(19) United States
(12) Patent Application Publication
(10) Pub. No.: US 2020/0089088 A1
(43) Pub. Date: Mar. 19, 2020

(54) DUAL CAMERA MODULE

(71) Applicant: RBKEMD CO., LTD., Anyang-si, Gyeonggi-do (KR)

(72) Inventors: Jae Wook RYU, Seoul (KR); He Won JUNG, Ansan-si, Gyeonggi-do (KR); Ju Hyun JEON, Ansan-si, Gyeonggi-do (KR); Deok Yul LEE, Ansan-si, Gyeonggi-do (KR); Kyu Chung NAM, Ansan-si, Gyeonggi-do (KR)

(21) Appl. No.: 15/780,106

(22) PCT Filed: Jul. 27, 2017
(86) PCT No.: PCT/KR2017/008097

§ 371 Date: May 30, 2018

(30) Foreign Application Priority Data
Sep. 9, 2016 (KR) 10-2016-0116657

(51) Int. Cl. G03B 19/22; G02B 7/09; G03B 13/34; H04N 5/225

(52) U.S. Cl. CPC G03B 19/22; G02B 7/09; G03B 2205/0069; H04N 5/2254; G03B 13/34

(57) ABSTRACT

A dual camera module is provided to independently control the two photographing lenses located in a magnetic field formed by the same magnetic field generating source. The dual camera module includes: a first movable part including a first lens and configured to move in parallel to an optical axis of the first lens; a second movable part including a second lens and configured to move in parallel to an optical axis of the second lens; and a common magnetic field generating part configured to generate a magnetic field around the first movable part and the second movable part to generate electromagnetic forces in the first movable part and the second movable part, respectively, so that the first movable part and the second movable part move independently.

### TECHNICAL FIELD

The present invention relates to a dual camera module including two photographing lenses, and more particularly, to a dual camera module that may independently control two photographing lenses located in a magnetic field formed by the same magnetic field generating source.

### BACKGROUND ART

In general, a camera module has a small size and a light weight and is mounted on a portable terminal, such as a smartphone. Recently, thanks to the development of portable terminals, multifunctional and high-performance camera modules have been requested. The camera module has a representative function of adjusting a focal distance between an image sensor and a lens. Further, in recent years, two camera modules have been mounted on a portable terminal for a function, such as recognition of an iris.

A conventional dual camera module is disclosed in Korean Patent Application Publication No. 10-2015-0113675. FIG. 1 is an exploded perspective view illustrating a configuration of a conventional dual camera module.

The conventional dual camera module includes a base member 20 that couples first and second lens assemblies 30 and 40 and first and second driving parts 50 and 60 configured to drive the first and second lens assembly parts upwards and downwards in an optical axis direction; and first and second covers 70 and 80 coupled to the base member, and the first and second driving parts are disposed on one side surface of the base member.

However, because the conventional dual camera module has to include both the first and second driving parts to drive the first and second lens assemblies and a first magnetic body 31 and a second magnetic body 41 included in the first and second driving parts have to be disposed such that a distance between the first magnetic body and the second magnetic body may be maximized to avoid an interference between magnetic fields by the first and second magnetic bodies, it is difficult to maintain the small size and the light weight of the dual camera module. Otherwise, a separate configuration that may shield a magnetic field between the first magnetic body and the second magnetic body has to be added, this also hampers the small size and the light weight of the dual camera module.

### DISCLOSURE

### Technical Problem

The present invention has been made in an effort to solve the above-mentioned problems, and provides a dual camera module that may prevent an interference of a magnetic field by a magnetic field generating source and may easily achieve a small size and a light weight by independently controlling two photographing lenses located in the magnetic field formed by the magnetic field generating source.

### Technical Solution

In accordance with an aspect of the present invention, there is provided a dual camera module including: a first movable part including a first lens and configured to move in parallel to an optical axis of the first lens; a second movable part including a second lens and configured to move in parallel to an optical axis of the second lens; a common magnetic field generating part configured to generate a magnetic field around the first movable part and the second movable part to generate electromagnetic forces in the first movable part and the second movable part, respectively, so that the first movable part and the second movable part move independently; and a housing in which the first movable part and the second movable part are movably disposed and on which the common magnetic field generating part is mounted.

The first movable part may include: a first lens barrel, to which the first lens is coupled; and a first coil part mounted on the first lens barrel to face the common magnetic field generating part, and the second movable part may include: a second lens barrel, to which the second lens is coupled; and a second coil part mounted on the second lens barrel to face the common magnetic field generating part, and the common magnetic field generating part may be mounted between the first movable part and the second movable part to divide an interior space of the housing and generates the magnetic field around the first coil part and the second coil part.

The common magnetic field generating part may include a first magnet and a second magnet, the first magnet may have opposite polarities on sides that face the first coil part and the second coil part, respectively, and polarities of the second magnet may be opposite to the polarities of the first magnet. The dual camera module may further include: a first elastic part including: a first member one end of which is mounted to the housing and to protrude in a first direction that faces the common magnetic field generating unit; and a second member that is bent from the first member to protrude in a second direction that is opposite to the first direction and is mounted to the first movable part; and a second elastic part including: a third member, one end of which is mounted on the housing to protrude in the second direction; and a fourth member that is bent from the third member to protrude in the first direction and is mounted to the second movable part.

One end of the first member may be deflected with respect to an opposite end of the first member, which is fixed to the housing, if a current flows through the first coil part so that the first movable part moves in the second direction by a specific distance, and the second member fixed to the first movable part may be deflected with respect to the one end of the first member so that the first movable part moves in the first direction by a specific distance, and one end of the third member may be deflected with respect to an opposite end of the third member, which is fixed to the housing, if a current flows through the second coil part so that the second movable part moves in the first direction by a specific distance, and the fourth member fixed to the second movable part may be deflected with respect to the one end of the fourth member so that the second movable part moves in the second direction by a specific distance.

### Advantageous Effects

According to the present invention, an interference between magnetic fields by a plurality of magnetic field generating sources are not generated by independently performing a control such that the optical axes of the lenses of the first movable part and the second movable part located in the magnetic field formed by a common magnetic field generating part may move in parallel to each other, and accordingly, a separate shield structure is not necessary and the whole structure of the dual camera module may be advantageously small-sized and light-weighted.

### DESCRIPTION OF THE DRAWINGS

FIG. 1 is an exploded perspective view illustrating a configuration of a conventional dual camera module;

FIG. 2 is a perspective view of a dual camera module according to an embodiment of the present invention;

FIG. 3 is an exploded perspective view of a dual camera module, except for a cover, according to an embodiment of the present invention;

FIG. 4 is a sectional view taken along line A-A of FIG. 2;

FIG. 5 is a plan view of a first elastic part and a second elastic part according to an embodiment of the present invention;

FIG. 6 is a perspective view of a dual camera module, except for a cover, according to an embodiment of the present invention; and

FIG. 7 is a view schematically illustrating an operation form of the first elastic part according to an embodiment of the present invention.

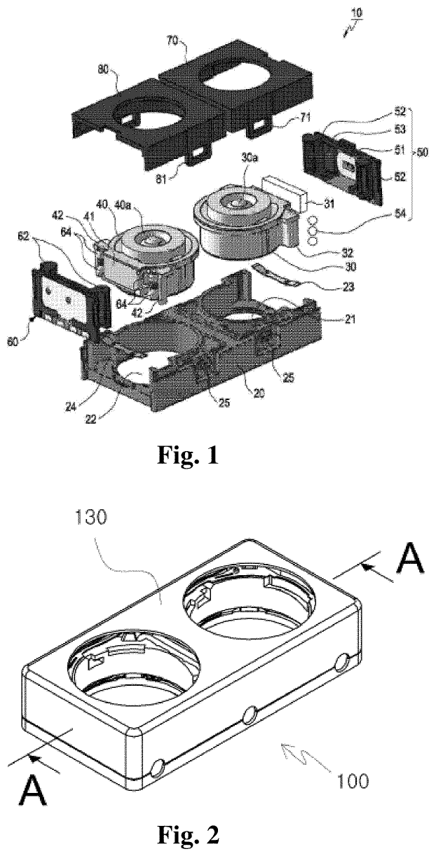

### BEST MODE

### Mode

The present invention relates to a dual camera module that may independently control two photographing lenses located in a magnetic field formed by the same magnetic field generating source, and an interference by a magnetic field generated by a plurality of magnetic field generating sources may be avoided and the dual cameral module may be small-sized and light-weighted.

Hereinafter, the present invention will be described in detail with reference to the accompanying drawings.

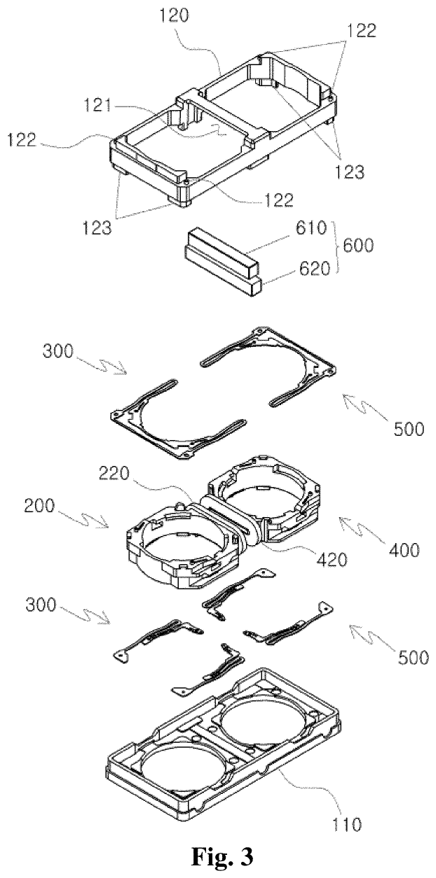

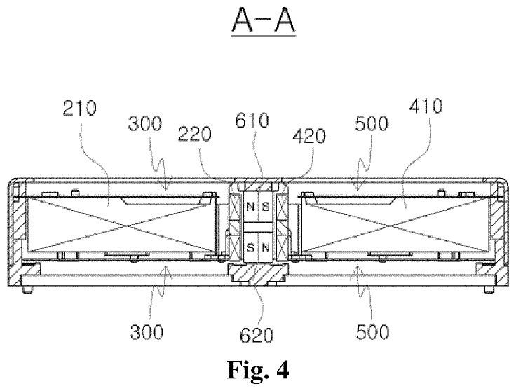

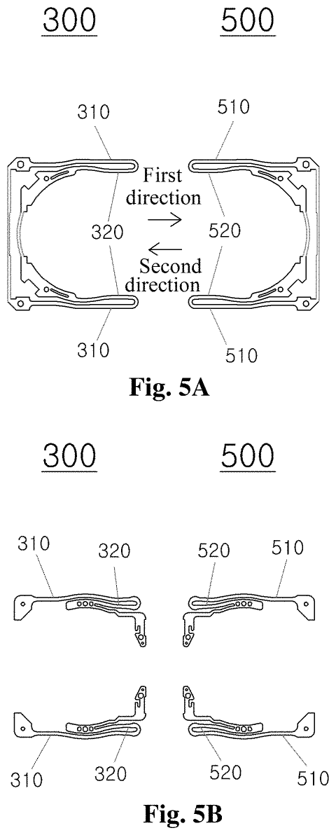

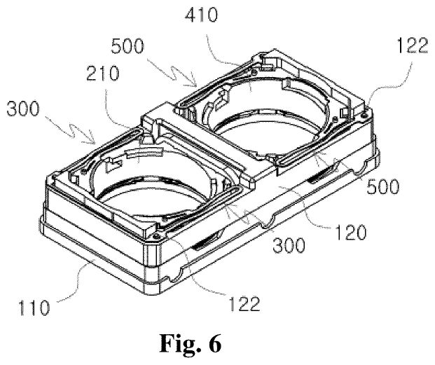

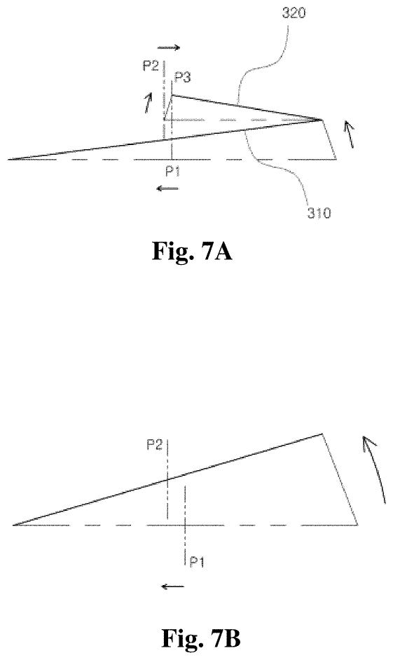

FIG. 2 is a perspective view of a dual camera module according to an embodiment of the present invention. FIG. 3 is an exploded perspective view of a dual camera module, except for a cover, according to an embodiment of the present invention. FIG. 4 is a sectional view taken along line A-A of FIG. 2. Further, FIG. 5A illustrates a first elastic part and a second elastic part located above a first movable part and a second movable part, and FIG. 5B illustrates a first elastic part and a second elastic part located below the first movable part and the second movable part. FIG. 6 is a perspective view of a dual camera module, except for a cover, to show an internal coupling structure of the dual camera module according to an embodiment of the present invention. Further, FIG. 7A is a view schematically illustrating an operation form of a first elastic part according to the present invention, and FIG. 7B is a view schematically illustrating an operation form of an elastic body in a general cantilever form.

As illustrated in FIGS. 2 to 7, the dual camera module according to an embodiment of the present invention includes a housing 100, a first movable part 200, a first elastic part 300, a second movable part 400, a second elastic part 500, and a common magnetic field generating part 600.

The housing 100 is disposed such that the first movable part 200 and the second movable part 400 are movable, and the common magnetic field generating part 600 is mounted on the housing 100. As illustrated in FIGS. 2 and 3, the housing 100 includes a hub 110, a spacer 120, and a cover 130.

The spacer 120 is mounted on an upper side of the hub 110 to form a space in which the first movable part 200 and the second movable part 400 are disposed. Further, as illustrated in FIG. 3, a coupling recess 121, to which the common magnetic field generating part 600 is slidably coupled, is formed at a central portion of the spacer 120. Because the common magnetic field generating part 600 is coupled to the coupling recess 121, an interior space of the housing 100 is divided into two parts such that the first movable part 200 and the second movable part 400 are separately disposed in the respective spaces. Further, upper protrusions 122 are formed at upper corners of the spacer 120, and lower protrusions 123 are formed at lower corners of the spacer 120. A first elastic part 300 and a second elastic part 500 are fixedly mounted on each of the upper protrusions 122 and the lower protrusions 123, respectively. Further, the cover 130 is mounted to the hub 110 to cover the first movable part 200 and the second movable part 400.

The first movable part 200 is disposed in the interior of the housing 100 to move in parallel to the optical axis of a first lens. The first movable part 200 includes a first lens (not illustrated), a first lens barrel 210, and a first coil part 220. The first lens is coupled to the inside of the first lens barrel 210, and as illustrated in FIG. 4, the first coil part 220 is mounted on an outside of the first lens barrel 210 to face the common magnetic field generating part 600.

The first elastic part 300 elastically supports the first movable part 200 to return the first movable part 200 that moves in parallel to the optical axis of the first lens to an original location. As illustrated in FIG. 5, the first elastic part 300 includes a pair of first members 310 and a pair of second members 320 that are integrally formed. Ends of the first members 310 are mounted on the housing 100 to protrude in a first direction that faces the common magnetic field generating part 600. The second members 320 are bent from the corresponding first members 310 to protrude in a second direction that is opposite to the first direction, and is mounted on the first movable part 200.

The first elastic part 300 elastically supports the first movable part 200 on opposite upper sides and opposite lower sides of the first movable part 200. As illustrated in FIG. 5A, the first elastic part 300 located on the opposite upper sides of the first movable part 200 are connected to each other and ends of the first members 310 are fixedly mounted to the corresponding upper protrusions 122. Further, the first elastic part 300 located on the opposite lower sides of the first movable part 200 is configured such that ends of the first members 310 are fixedly mounted on the corresponding protrusions 123.

The second movable part 400 is disposed in the interior of the housing 100 to move in parallel to the optical axis of a second lens. The second movable part 400 includes a second lens (not illustrated), a second lens barrel 410, and a second coil part 420. The second lens is coupled to the inside of the second lens barrel 410, and as illustrated in FIG. 4, the second coil part 420 is mounted on an outside of the second lens barrel 410 to face the common magnetic field generating part 600.

The second elastic part 500 elastically supports the second movable part 400 to return the second movable part 400 that moves in parallel to the optical axis of the second lens to an original location. As illustrated in FIG. 5, the second elastic part 500 includes a pair of third members 510 and a pair of fourth members 520 that are integrally formed. Ends of the third members 510 are mounted on the housing 100 to protrude in a second direction that faces the common magnetic field generating part 600. The fourth members 520 are bent from the corresponding second members 320 to protrude in the first direction, and are mounted on the second movable part 400.

The second elastic part 500 elastically supports the second movable part 400 on opposite upper sides and opposite lower sides of the second movable part 400. As illustrated in FIG. 5A, the second elastic part 500 located on the opposite upper sides of the second movable part 400 are connected to each other and ends of the third members 510 are fixedly mounted to the corresponding upper protrusions 122. Further, the second elastic part 500 located on the opposite lower sides of the second movable part 400 is configured such that ends of the third members 510 are fixedly mounted on the corresponding protrusions 123.

The common magnetic field generating part 600 generates a magnetic field around the first movable parts 200 and the second movable part 400 so that electromagnetic forces may be generated in the first movable part 200 and the second movable part 400, respectively, to independently move the first movable part 200 and the second movable part 400. The common magnetic field generating part 600 is slidably coupled to the coupling recess 121 of the spacer 120.

In detail, as illustrated in FIG. 4, the common magnetic field generating part 600 is classified into a first magnet part 610 and a second magnet part 620 located on the upper and lower sides. Further, opposite polarities are formed on sides of the first magnet part 610, which face the first coil part 220 and the second coil part 420, respectively, and the polarities of the second magnet part 620 are opposite to those of the first magnet parts 610.

In this way, according to the present invention, an interference between magnetic fields by a plurality of magnetic field generating sources is not generated because electromagnetic forces are generated in the first movable part 200 and the second movable part 400 by using the common magnetic field generating part 600, and accordingly, a separate shield structure is not necessary and the whole structure of the dual camera module may be advantageously small-sized and light-weighted.

Hereinafter, an operation structure of the dual camera module according to an embodiment of the present invention will be described.

First, in an initial state, the first movable part 200 and the second movable part 400 are in contact with the hub 110, and a magnetic field is formed around the first coil part 220 and the second coil part 420 by the common magnetic field forming part.

If a current flows in any one direction in the first coil part 220 in the initial state, an electromagnetic force that moves the first movable part 200 is generated so that the first movable part 200 moves in parallel to the optical axis of the first lens.

Then, the first elastic part 300 is deflected as the first movable part 200 moves. In detail, as illustrated in FIG. 7A, one end of the first member 310 is deflected with respect to an opposite end of the first member 310 fixed to the spacer 120 so that the first movable part 200 moves in a second direction (P1→P2) by a specific distance, and the second member 320 fixed to the first movable part 200 is deflected with respect to the one end of the first member 310 so that the first movable part 200 moves in a first direction (P2→P3) by a specific distance. Meanwhile, as illustrated in FIG. 7B, the elastic body having a general cantilever form is deflected when the first movable part 200 moves so that the first movable part 200 is displaced (P1→P2). Due to the displacement, the focal location of the first lens and the center of the image sensor do not coincide with each other so that the quality of the captured image deteriorates.

However, according to the present invention, distortion of the focal location of the first lens and the center of the image sensor may be minimized because the directions of the displacement of the first movable part 200 by the deflection of the first member 310 and the displacement of the first movable part 200 by the deflection of the second member 320 are opposite to each other and the displacement (P1→P2) by the first member 310 and the displacement (P2→P3) by the second member 320 are offset while the displacements of the first movable part 200 due to the deformations of the members decrease.

Thereafter, if electric power to the first coil part 220 is interrupted, the first movable part 200 returns to the original location due to the first resilient part 300.

Further, if a current flows in the second coil part 420 in the initial state, an electromagnetic force that moves the second movable part 400 is generated so that the second movable part 400 moves in parallel to the optical axis of the second lens.

Then, one end of the third member 510 is deflected with respect to an opposite end of the third member 510 fixed to the spacer 120 so that the second movable part 400 moves in the first direction by a specific distance, and the fourth member 420 fixed to the second movable part 400 is deflected with respect to the one end of the third member 510 so that the second movable part 400 moves in the second direction by a specific distance.

Thereafter, if electric power to the second coil part 420 is interrupted, the second movable part 400 returns to the original location due to the second resilient part 500.

Operation forms of the second movable part 400 and the second elastic part 500 are the same as those of the first movable part 200 and the first resilient part 300, and will not be illustrated separately.

The dual camera module according to the present invention is not limited to the above-mentioned embodiments, and may be variously deformed without departing from the spirit of the present invention.

1. A dual camera module comprising:
a first movable part including a first lens and configured to move in parallel to an optical axis of the first lens;
a second movable part including a second lens and configured to move in parallel to an optical axis of the second lens;
a common magnetic field generating part configured to generate a magnetic field around the first movable part and the second movable part to generate electromagnetic forces in the first movable part and the second movable part, respectively, so that the first movable part and the second movable part move independently; and
a housing in which the first movable part and the second movable part are movably disposed and on which the common magnetic field generating part is mounted.

2. The dual camera module of claim 1, wherein the first movable part includes:
a first lens barrel, to which the first lens is coupled; and
a first coil part mounted on the first lens barrel to face the common magnetic field generating part,
wherein the second movable part includes:
a second lens barrel, to which the second lens is coupled; and
a second coil part mounted on the second lens barrel to face the common magnetic field generating part, and
wherein the common magnetic field generating part is mounted between the first movable part and the second movable part to divide an interior space of the housing and generates the magnetic field around the first coil part and the second coil part.

3. The dual camera module of claim 2, wherein the common magnetic field generating part includes a first magnet and a second magnet,
wherein the first magnet has opposite polarities on sides that face the first coil part and the second coil part, respectively, and
wherein polarities of the second magnet are opposite to the polarities of the first magnet.

4. The dual camera module of claim 1, further comprising:
a first elastic part including:
a first member one end of which is mounted to the housing and to protrude in a first direction that faces the common magnetic field generating unit; and
a second member that is bent from the first member to protrude in a second direction that is opposite to the first direction and is mounted to the first movable part; and
a second elastic part including:
a third member, one end of which is mounted on the housing to protrude in the second direction; and
a fourth member that is bent from the third member to protrude in the first direction and is mounted to the second movable part.

5. The dual camera module of claim 4, wherein one end of the first member is deflected with respect to an opposite end of the first member, which is fixed to the housing, if a current flows through the first coil part so that the first movable part moves in the second direction by a specific distance, and the second member fixed to the first movable part is deflected with respect to the one end of the first member so that the first movable part moves in the first direction by a specific distance, and one end of the third member is deflected with respect to an opposite end of the third member, which is fixed to the housing, if a current flows through the second coil part so that the second movable part moves in the first direction by a specific distance, and the fourth member fixed to the second movable part is deflected with respect to the one end of the fourth member so that the second movable part moves in the second direction by a specific distance.
